(19) United States
(12) Patent Application Publication
(10) Pub. No.: US 2019/0197589 A1
(43) Pub. Date: Jun. 27, 2019

(54) METHOD AND SYSTEM FOR FACILITATING OPERATION OF AN ENTITY

(71) Applicants: Harpal Singh, Murphy, TX (US); Gursneh Nanak Kaur, Murphy, TX (US); Vijit Nanak Singh, Murphy, TX (US); Jaskiran Kaur, Murphy, TX (US)

(72) Inventors: Harpal Singh, Murphy, TX (US); Gursneh Nanak Kaur, Murphy, TX (US); Vijit Nanak Singh, Murphy, TX (US); Jaskiran Kaur, Murphy, TX (US)

(21) Appl. No.: 15/855,035

(22) Filed: Dec. 27, 2017

(51) Int. Cl. G06Q 30/02; G06Q 20/02; G06Q 20/32; G06N 5/02; G06F 9/44

(52) U.S. Cl. CPC G06Q 30/0279; G06Q 20/027; G06F 9/4443; G06N 5/02; G06Q 20/322

(57) ABSTRACT

Disclosed is a method of facilitating operation of an entity. The method may include receiving, using a communication device, an event data corresponding to an event associated with the entity. Further, the method may include receiving, using the communication device, user data from two or more mobile devices associated with two or more users. Yet further, the method may include identifying, using a processing device, one or more users based on each of the event data and the user data. Further, the method may include transmitting, using the communication device, one or more notifications to the one or more mobile devices based on the identifying. Moreover, the method may include receiving, using the communication device, an indication of a donation from the one or more mobile devices. The donation may be associated with the event.

### FIELD OF THE INVENTION

The present invention relates to the operation of entities. In particular, the present invention relates to techniques for facilitating operation of entities such as non-profit organizations, companies, clubs, and missions.

### BACKGROUND OF THE INVENTION

In general, people engage with various entities, such as non-profit organizations, companies, clubs, and missions. People may wish to contribute to such entities on a regular basis. Further, people may wish to receive notifications about new events related to such entities. Often, such entities do not have sufficient online presence that would keep their members engaged, raise donation and also help them expand their membership.

Therefore, they have no easy way track members or send them notifications. Often, members do not read the emails. Further, social media posts are not always read by the members. Moreover, the members have to make an extra effort to visit the website of these entities. Therefore, the members may miss contributing to a fundraiser or may miss renewing their membership.

Accordingly, there is a need for methods and systems for facilitating operation of an entity in an efficient manner, which allows the members of the entity to receive notifications and contribute to the entity.

### SUMMARY OF THE INVENTION

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

Disclosed is a method of facilitating operation of an entity. The method may include receiving, using a communication device, an event data corresponding to an event associated with the entity. Further, the method may include receiving, using the communication device, user data from two or more mobile devices associated with two or more users. Yet further, the method may include identifying, using a processing device, one or more users based on each of the event data and the user data. Further, the method may include transmitting, using the communication device, one or more notifications to the one or more mobile devices based on the identifying. Moreover, the method may include receiving, using the communication device, an indication of a donation from the one or more mobile devices. The donation may be associated with the event.

According to further aspects, a system for facilitating operation of an entity is disclosed. The system may include a communication device configured for receiving an event data corresponding to an event associated with the entity. Further, the communication device may be configured for receiving user data from two or more mobile devices associated with two or more users. Yet further, the communication device may be configured for transmitting one or more notifications to the one or more mobile devices associated with one or more users. Further, the communication device may be configured for receiving an indication of a donation from the one or more mobile devices. The donation may be associated with the event. Yet further, the system may include a processing device configured for identifying the one or more users based on each of the event data and the user data.

According to some aspects, a customized mobile application is disclosed. The customized mobile application provides a robust mobile presence to entities that would benefit the entities and their members. Further, the customized mobile application may allow entities to organize fundraisers.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 illustrates an exemplary environment in which embodiments of the present disclosure may be implemented.

FIG. 2 is a block diagram of a system for facilitating operation of an entity, in accordance with some embodiments.

FIG. 3 illustrates a flowchart of a method for facilitating operation of an entity, in accordance with some embodiments.

FIG. 4 illustrates a flowchart of a method for providing a customized user interface, in accordance with some embodiments.

FIG. 5 illustrates a flowchart of a method for obtaining a donation, in accordance with some embodiments.

FIG. 6 illustrates a flowchart of a method for charging a service fee for facilitating operation of an entity, in accordance with some embodiments.

FIG. 7 illustrates a flowchart of a method for generating one or more prediction models associated with the one or more users, in accordance with some embodiments.

FIG. 8 illustrates a flowchart of a method for facilitating multiple entities, in accordance with some embodiments.

FIG. 9 is a block diagram illustrating linking of customized mobile applications of various entities for a particular member, in accordance with an exemplary embodiment.

FIG. 10 illustrates a user interface of a customized mobile application, in accordance with an exemplary embodiment.

FIG. 11 illustrates a user interface of a customized mobile application in accordance with an exemplary embodiment.

FIG. 12 illustrates an exemplary computing system that may be employed to implement processing functionality for various embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of facilitating operation of entities, embodiments of the present disclosure are not limited to use only in this context.

### Overview

According to some aspects, the present disclosure relates to a customized mobile application, which may be named “Nonprofit Mart”. The customized mobile application is designed to facilitate entities such as non-profit organizations and other organizations across the world to meet their critical goals of keeping target audience engaged, involved and preserve their brand. The customized mobile application may communicate with a backend cloud computing and Artificial Intelligence platform. The customized mobile application is easy to set up and has virtually no maintenance cost. The customized mobile application allows sending out notifications about events and initiatives, receiving contributions and donations in a safe and secure manner, reaching out to volunteers and manage volunteer programs, increasing the membership and expanding the outreach.

According to further aspects, the customized mobile application may allow entities to run big data reports and analytics of their advertising initiatives and maximize returns using artificial intelligence, machine learning, and deep learning algorithms.

Further, the customized mobile application may be fully integrated and authenticated for use with commonly used applications such as PayPal™. Further, the customized mobile application may be configured to receive donations in cryptocurrency, such as Bitcoin.

Yet further, the customized mobile application may be fully customized for a particular entity. Then, the application may be published in an application store (such as Google Play Store™) under the name of the particular entity. This will help the entity preserve its brand name.

Moreover, the customized mobile application may allow entities to stay connected and maintain constant contact with their members. The customized mobile application may help in creating and maintaining the micro-communication among members who are faithful to the mission of a particular entity.

Further, the customized mobile application may provide APIs to push events and other data from the website of an entity to the corresponding customized mobile application. The customized mobile application may also provide content management which will enable entities to publish articles and other content for their base.

Further, the customized mobile application may allow integration with health measuring devices (such as a pedometer in a smartphone) and other wearable devices (such as smartwatch) to measure various physiological parameters, such as heart rate or blood pressure.

Further, the customized mobile application may allow entities to focus on serving their mission and vision. The customized mobile application may also provide multi-lingual support, which will enable entities to expand their reach.

Further, the customized mobile application may include many features. A login feature may require one or more of a cell phone number, an email address, and a password. The login may employ two-factor authentication. Further, email address and the cell phone number may be verified with an OTP (one-time password). The customized mobile application may allow users to create profiles. A user profile may include one or more of the first name, middle name, last name, email id, phone number, photograph. Further, the profile may include a title (such as Director, CEO or CFO) if the user is an administrator. The customized mobile application may allow users to create profiles of the entities such as an organization, an association and a company. The entity profile may include one or more of legal name, type (Like 501(3) (C), Not for Profit, S-Corp, Personal), legal address, the name of the trustee/director, tax id, and state incorporated in.

Moreover, the customized mobile application may allow users to customize the application. This includes providing an ability to customize color, logo and fill in a mission statement. Further, it includes providing an option to show all members or keep member Anonymous and select a Time Zone (default may be CST).

Moreover, the customized mobile application may allow administrators to send notifications to members. However, the customized mobile application may be configured to allow anyone in the application to send a notification. An administrator may control this feature.

Further, the customized mobile application may allow users to create an event by providing event details, which may include, one or more of Event Title, Event Date (date, start time, time zone and Duration), and Event Location (Address). The event location may be mapped on location maps like Google Map™ and may be tracked. Further, the event details may include Contact Person Name, email ID and telephone. Users may upload event logo, a background theme, pictures and video. Further, the customized mobile application may allow users to upload and share event pictures and Video and MP3 songs; integrate the event location with weather maps; upload, play and embed MP3 sermon or book reading sample or music for the event (like book sample reading); upload, play and embed video; add event to calendar; accept and track how many people are coming for the event and post the event to social media platforms directly.

Further, the customized mobile application may allow users to chat, share pictures and video, make telephone or video call to each other, conduct webinars, conduct one to one session with Gurdwara Bhai Saab (Priest) on reporting any topic like confession in Church.

Further, the customized mobile application may provide an e-commerce platform wherein the users may put products and sell them.

Further, the customized mobile application may pre-populate the events or calendar based on the type, such as Gurpurab days or Diwali day or FIFA championship or NFL or NBA or Cricket. The customized mobile application may pre-populate events like US Nations Holidays like Mother's Day etc. Further, the customized mobile application may pre-populate events for various religions. Moreover, the customized mobile application may allow users to create an event directly from the calendar. Further, a provider of the customized mobile application may charge a donations and/or membership fee. For example, 1% from any monies collected from the mobile application may be charged as “application maintenance fee”. The donations may be made one time or reoccurring. The membership may be paid and membership expiry date may be displayed. A notification may also be setup before the membership expires. Further, the customized mobile application may be integrated with PayPal, Cryptocurrency and other payment gateways. Further, the customized mobile application may accept physical objects (like car) or Stocks as donations. Further, the customized mobile application may allow users to donate time. After the donation is received, the customized mobile application may display and email the receipt.

Further, the customized mobile application may allow users to conduct surveys with members.

Further, the customized mobile application may allow users to run reports and save them as PDF. The reports may be emailed to administrators as PDF documents.

Further, the customized mobile application may allow administrators to export data. Further, the customized mobile application may allow administrators to add external links (like referring to their own website or any other article on the internet).

Further, the customized mobile application may provide an option to contact administrators/organizers. This may include allowing posting the product improving/suggestion emails, allowing an administrator to cancel a plan, report mobile application or content abuse and discuss and post questions

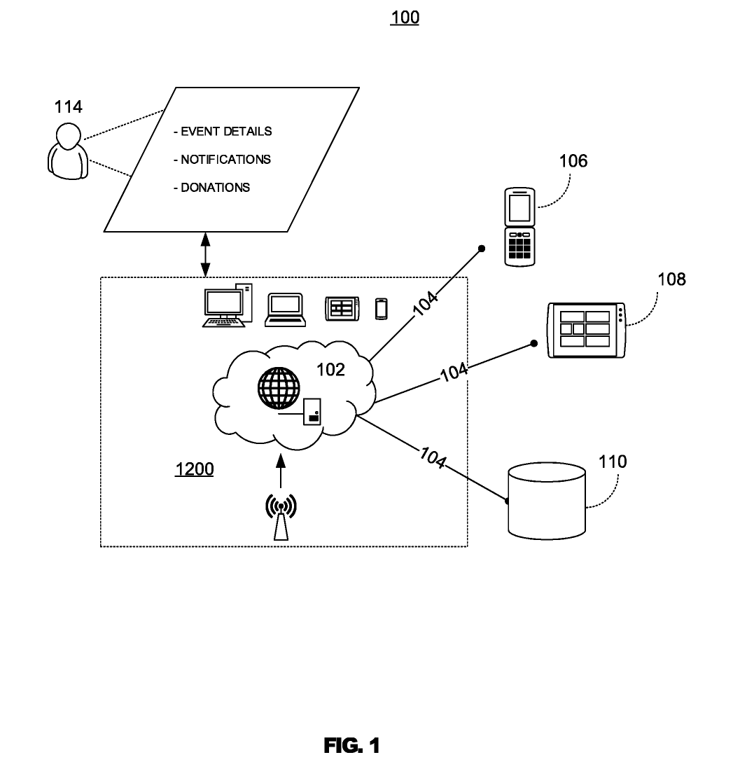

Referring now to figures, FIG. 1 is an illustration of a platform consistent with various embodiments of the present disclosure. By way of non-limiting example, the online platform 100 for facilitating operation of an entity, may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 108 (such as, a desktop computer, etc.), external server associated with company stocks 110 over a communication network 104, such as, but not limited to, the Internet. Further, users of the platform 100 may include one or more relevant parties such as employees, managers, owners of entities, members of entities and donors. Accordingly, electronic devices operated by the one or more relevant parties may be in communication with the platform 100. For example, the entities may include non-profit organizations such as faith based organizations and clubs (such as book clubs, sports clubs, dance clubs).

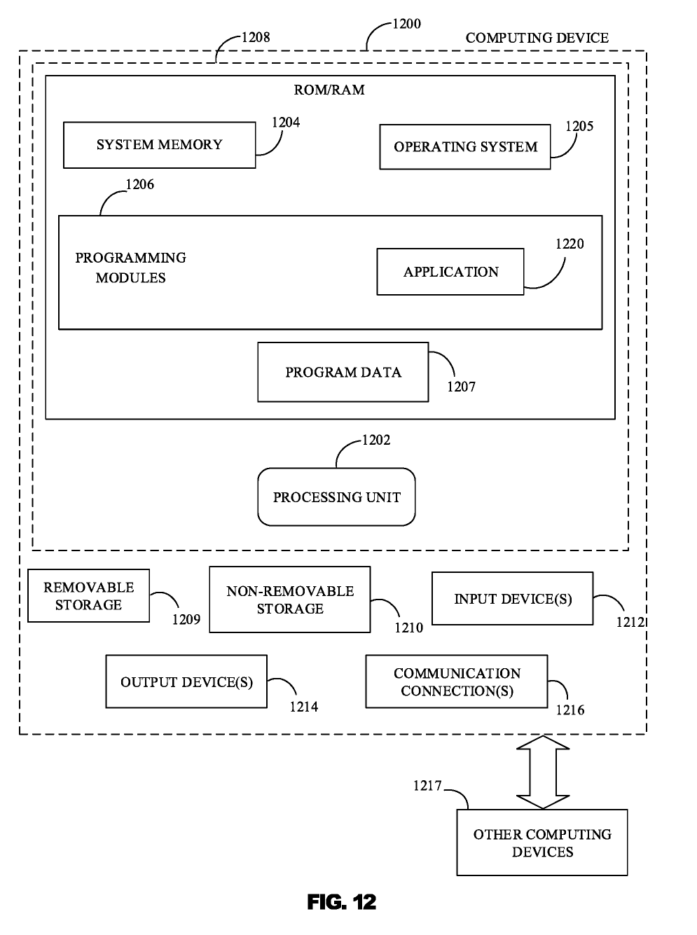

A user 114, such as the one or more relevant parties, may access platform 100 through a software application. The software application may be embodied as, for example, but not be limited to, a website, a web application, a desktop application, a mobile application and a gaming machine application compatible with a computing device 1200. The computing device 1200 is explained in further detail in conjunction with FIG. 12 below.

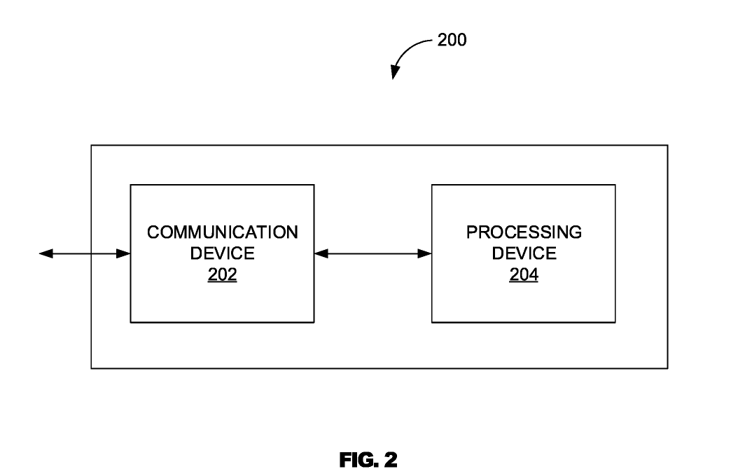

FIG. 2 is a block diagram of a system 200 for facilitating operation of an entity, in accordance with some embodiments. The system 200 may include a communication device 202 configured for receiving an event data corresponding to an event associated with the entity. Further, the communication device 202 may be configured for receiving user data from two or more mobile devices (such as the mobile device 106 and the electronic device 108) associated with two or more users. The user data may include any data corresponding to a user. For example, the user data may include one or more of profile information such as, but not limited to, personal information (such as name, and address), interests (such as topics, places, people, and events), demographic information (such as location, income group, education, and profession), historical user interaction information (responses to previously sent notifications, and event attendance), user behavior data (such as distance covered by walking/running), and physiological variables (such as heartbeat and blood pressure).

Yet further, the communication device 202 may be configured for transmitting one or more notifications to the one or more mobile devices associated with one or more users. In some embodiments, the one or more notifications may include information regarding one or more of a past event, a current event and an upcoming event.

Accordingly, the one or more notifications may include any event name, an event location, an event time, an event duration, an event agenda, and an event media (such as audio, video, image, and multimedia).

In some embodiments, the one or more notifications may include multiple indications corresponding to multiple types of donations. For example, the multiple types of donations may include a monetary donation, such as national currencies (including, but not limited to, US dollars, Canadian dollars, Euros, Swiss Francs, Japanese Yen), cryptocurrencies (including, but not limited to, Bitcoin, Ethereum, Litecoin, Monero, Ripple, and Zcash), a donation of voluntary service time, a donation of a used/unused product, company stocks, coupons, and gift-cards.

Further, the communication device 202 may be configured for receiving an indication of a donation from the one or more mobile devices. The donation may be associated with the event. According to some embodiments, the indication of the donation may correspond to a monetary value. Accordingly, one or both of the online platform 100 and the system 200 may be configured to present a payment gateway to a mobile device from which the indication was received. As a result, a user of the mobile device may be enabled to make the donation through the payment gateway.

According to some other embodiments, the indication of the donation may correspond to one or more of, but not limited to, physical objects, company stocks, and time. Accordingly, one or both of the online platform 100 and the system 200 may be configured to facilitate receiving of the donation. For instance, one or both of the online platform 100 and the system 200 may communicate with an external server associated with company stocks in order to fulfill the donation of a predetermined number of company stocks associated with a user.

Yet further, the system 200 may include a processing device 204 configured for identifying the one or more users based on each of the event data and the user data.

In some embodiments, the communication device 202 may be further configured for receiving customization data associated with the entity from a user device. The customization data may include any information that may be specific to a particular entity. For instance, in some embodiments, the customization data may include, but is not limited to, a name, a mission statement, a logo, a color scheme, a user interface scheme, and a workflow of the entity. Further, the communication device 202 may be configured for transmitting the customized user interface to the one or more mobile devices. Further, the processing device 204 may be configured for generating a customized user interface associated with the entity.

In some embodiments, the communication device 202 may be further configured for transmitting a payment gateway to the one or more mobile devices. Further, the communication device 202 may be configured for receiving payment information associated with the donation from the one or more mobile devices. Further, the processing device 204 may be configured for crediting an entity account associated with the entity based on the payment information.

In some embodiments, the processing device 204 may be further configured for determining a service fee based on the donation. The service fee may be associated with an online platform (such as the online platform 100) configured to facilitate operation of the entity. Further, the processing device 204 may be configured for crediting a platform account associated with the online platform based on the service fee.

In some embodiments, the user data may include one or more user responses corresponding to the one or more notifications from the one or more mobile devices. Further, the processing device 204 may be configured for analyzing the one or more user responses and generating one or more prediction models associated with the one or more users based on the analyzing. In general, the one or more prediction models represent one or more of a personality trait, a behavioral trait, a physical trait, a physiological trait, a psychological trait, a philanthropist trait. For example, in some embodiments a prediction model associated with a user may indicate a preference of the user with regard to a time of receiving a notification, a place corresponding to receiving the notification, a digital modality (such as a text, an image, an audio, and a video) corresponding to the notification, a type of donation, an amount of donation, a frequency of donation, and anonymity.

In some embodiments, the transmitting of the one or more notifications to the one or more mobile devices may be based on the one or more prediction models. Accordingly, in some embodiments, based on a prediction model of a user, a relevancy of a notification to the user may be determined. Accordingly, the transmitting of the notification to the user may be performed based on the relevancy. Further, in some embodiments, one or more parameters associated with the transmitting of the notification may be based on the prediction model. The one or more parameters may include, but are not limited to, a time of transmitting, a frequency of transmitting, a digital modality of transmitting, and a target user device corresponding to the transmitting.

In some embodiments, the processing device 204 may be further configured for customizing the one or more notifications based on the one or more prediction models. Accordingly, in some embodiments, contents of a notification may be adapted to suit a user. For example, a language of the notification may be selected according to one or more of a preference of the user and demographic information of the user. Further, in some embodiments, natural language processing may be used to customize the notification according to one or more of a personality trait, a behavioral trait, a physical trait, a physiological trait, a psychological trait and a philanthropist trait. For example, a degree of persuasion to be exercised on the user may be automatically determined based on the prediction model. Accordingly, words and/or phrases comprised in the notification may be selected to be consistent with the degree of persuasion.

In some embodiments, the processing device 204 may be further configured for determining one or more indications of one or more types of donation based on the one or more prediction models. Further, the one or more notifications may include the one or more indications of the one or more types of donation.

In some embodiments, the user data may further include sensor data corresponding to one or more sensors comprised in the one or more mobile devices. The one or more sensors may include, but are not limited to, one or more of a location sensor, an orientation sensor, a motion sensor, a sound sensor, an image sensor, a biometric sensor, a physiological sensor. Further, in some embodiments, the one or more mobile devices may include a wearable device such as, for example, a fitness band. Accordingly, the sensor data may include one or more of a physiological variable (such as heart rate, and blood pressure), a physical variable (such as a number of steps walked, and a distance covered by walking and/or running) and a psychological variable (such as level of stress as determined from correlation with physiological variables such as heart rate, EMG, and EEG). Further, the processing device 204 may be configured for analyzing the sensor data. Yet further, the generating of the one or more prediction models may be further based on the analyzing of the sensor data.

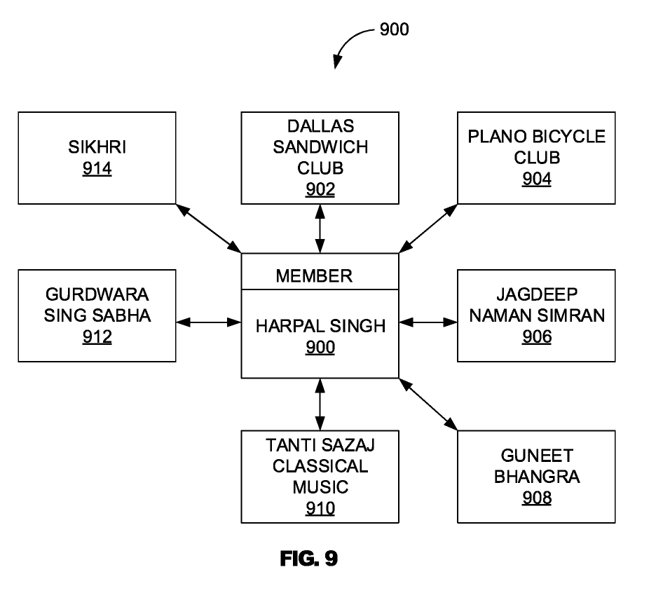

In some embodiments, the entity may include multiple entities. Further, the processing device 204 may be configured for aggregating each of the user data and the one or more notifications corresponding to the multiple entities. Further, the communication device 202 may be configured for transmitting an aggregated view to the one or more mobile devices based on the aggregating. In some embodiments, the aggregated view may enable a user to manage multiples events and/or corresponding notifications associated with multiple entities. For example, in some embodiments, the aggregated view may facilitate distribution of a total budget specified by the user among the multiple events, corresponding notifications and the multiple entities. This is explained in further detail in conjunction with FIG. 9 below.

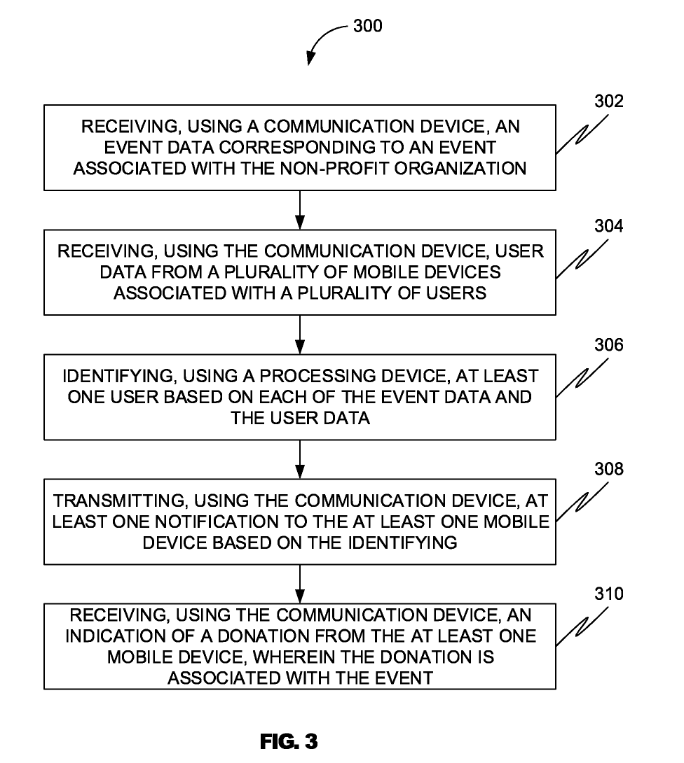

FIG. 3 illustrates a flowchart of a method 300 for facilitating operation of an entity, in accordance with some embodiments. At 302, the method 300 may include receiving, using a communication device (such as the communication device 202), an event data corresponding to an event associated with the entity.

At 304, the method 300 may include receiving, using the communication device, user data from two or more mobile devices associated with two or more users. In general, the user data may include any data corresponding to a user. For example, the user data may include one or more of profile information such as, but not limited to, personal information (such as name and address), interests (such as topics, places, people, and events), demographic information (such as location, income group, education, and profession), historical user interaction information (responses to previously sent notifications, and event attendance), user behavior data (such as distance covered by walking/running), and physiological variables (such as heartbeat and blood pressure).

At 306, the method 300 may include identifying, using a processing device (such as the processing device 204), one or more users based on each of the event data and the user data.

Next, at 308, the method 300 may include transmitting, using the communication device, one or more notifications to the one or more mobile devices based on the identifying.

In some embodiments, the one or more notifications may include information regarding one or more of a past event, a current event and an upcoming event. Accordingly, the one or more notifications may include any event name, an event location, an event time, an event duration, an event agenda, and an event media (such as audio, video, image, and multimedia).

In some embodiments, the one or more notifications may include multiple indications corresponding to multiple types of donations. For example, the multiple types of donations may include a monetary donation, such as national currencies (including, but not limited to, US dollars, Canadian dollars, Euros, Swiss Francs, Japanese Yen), cryptocurrencies (including, but not limited to, Bitcoin, Ethereum, Litecoin, Monero, Ripple, and Zcash), a donation of voluntary service time, a donation of a used/unused product, company stocks, coupons, and gift-cards.

At 310, the method 300 may include receiving, using the communication device, an indication of a donation from the one or more mobile devices. The donation may be associated with the event. According to some embodiments, the indication of the donation may correspond to a monetary value. Accordingly, an online platform (such as the online platform 100) may be configured to present a payment gateway to a mobile device from which the indication was received. As a result, a user of the mobile device may be enabled to make the donation through the payment gateway.

According to some other embodiments, the indication of the donation may correspond to one or more of, but not limited to, physical objects, company stocks, and time. Accordingly, the online platform may be configured to facilitate receiving of the donation. For instance, the online platform may communicate with an external server associated with company stocks in order to fulfil the donation of a predetermined number of company stocks associated with a user.

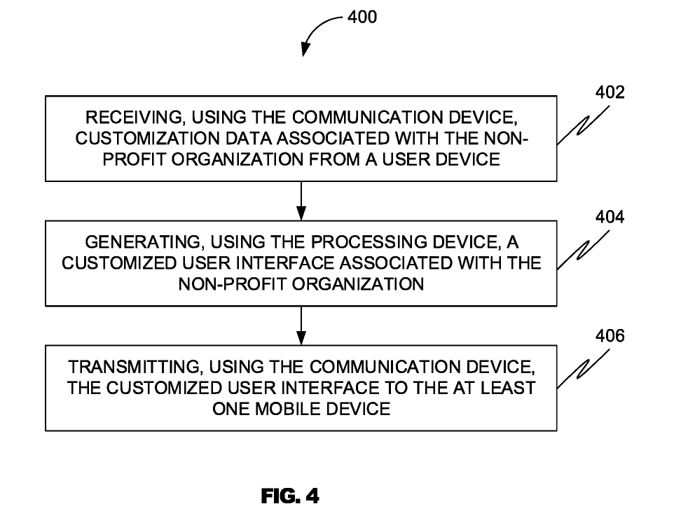

FIG. 4 illustrates a flowchart of a method 400 for providing a customized user interface, in accordance with some embodiments. At 402, the method 400 may include receiving, using the communication device, customization data associated with the entity from a user device. The customization data may include any information that may be specific to a particular entity. For instance, in some embodiments, the customization data may include, but is not limited to, a name, a mission statement, a logo, a color scheme, a user interface scheme, and a workflow of the entity. Further, the communication device may be further configured for transmitting the customized user interface to the one or more mobile devices. Further, the processing device may be further configured for generating a customized user interface associated with the entity.

At 404, the method 400 may include generating, using the processing device, a customized user interface associated with the entity. Then, at 406, the method 400 may include transmitting, using the communication device, the customized user interface to the one or more mobile devices.

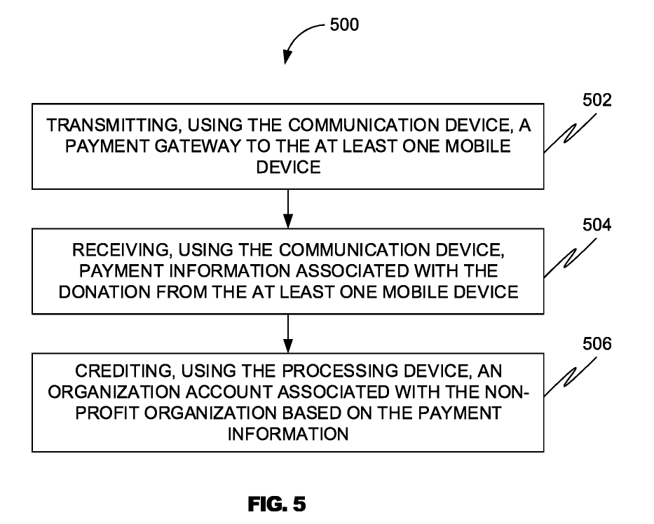

FIG. 5 illustrates a flowchart of a method 500 for obtaining the donation, in accordance with some embodiments. At 502, the method 500 may include transmitting, using the communication device, a payment gateway to the one or more mobile devices. At 504, the method 500 may include receiving, using the communication device, payment information associated with the donation from the one or more mobile devices; Then at 506, the method 500 may include crediting, using the processing device, an entity account associated with the entity based on the payment information.

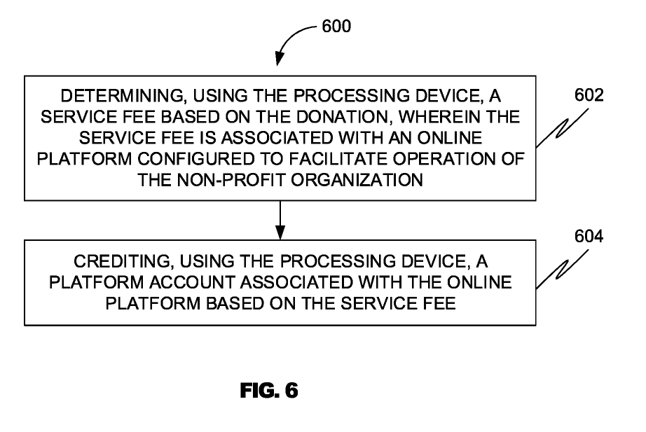

FIG. 6 illustrates a flowchart of a method 600 for charging a service fee for facilitating operation of an entity, in accordance with some embodiments. At 602, the method 600 may include determining, using the processing device, a service fee based on the donation. The service fee may be associated with an online platform (such as the online platform 100) configured to facilitate operation of the entity. At 604, the method 600 may include crediting, using the processing device, a platform account associated with the online platform based on the service fee.

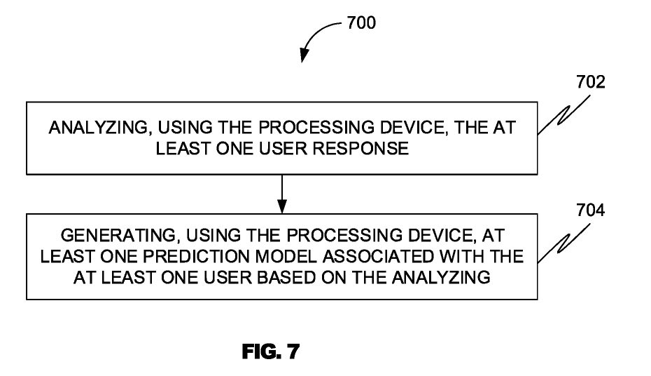

FIG. 7 illustrates a flowchart of a method 700 for generating one or more prediction models associated with the one or more users, in accordance with some embodiments. The user data may include one or more user responses corresponding to the one or more notifications from the one or more mobile devices. Accordingly, at 702, the method 700 may include analyzing, using the processing device, the one or more user responses.

At 704, the method 700 may include generating, using the processing device, the one or more prediction models associated with the one or more users based on the analyzing. In general, the one or more prediction models represent one or more of a personality trait, a behavioral trait, a physical trait, a physiological trait, a psychological trait, a philanthropist trait. For example, in some embodiments a prediction model associated with a user may indicate a preference of the user with regard to a time of receiving a notification, a place corresponding to receiving the notification, a digital modality (such as a text, an image, an audio, a video) corresponding to the notification, a type of donation, an amount of donation, a frequency of donation, and anonymity.

In some embodiments, the method 700 may further include transmitting of the one or more notifications to the one or more mobile devices may be based on the one or more prediction models. In further embodiments, based on a prediction model of a user, a relevancy of a notification to the user may be determined. Accordingly, the transmitting of the notification to the user may be performed based on the relevancy. Further, in some embodiments, one or more parameters associated with the transmitting of the notification may be based on the prediction model. The one or more parameters may include, but are not limited to, a time of transmitting, a frequency of transmitting, a digital modality of transmitting, and a target user device corresponding to the transmitting.

In some embodiments, the method 700 may further include customizing, using the processing device, the one or more notifications based on the one or more prediction models. Accordingly, in some embodiments, contents of a notification may be adapted to suit a user. For example, a language of the notification may be selected according to one or more of a preference of the user and demographic information of the user. Further, in some embodiments, natural language processing may be used to customize the notification according to one or more of a personality trait, a behavioral trait, a physical trait, a physiological trait, a psychological trait and a philanthropist trait. For example, a degree of persuasion to be exercised on the user may be automatically determined based on the prediction model. Accordingly, words and/or phrases comprised in the notification may be selected to be consistent with the degree of persuasion.

In some embodiments, the method 700 may further include determining, using the processing device, one or more indications of one or more types of donation based on the one or more prediction models. Further, the one or more notifications may include the one or more indications of one or more types of donation.

In some embodiments, the user data further may include sensor data corresponding to one or more sensors comprised in the one or more mobile devices. The one or more sensors may include, but are not limited to, one or more of a location sensor, an orientation sensor, a motion sensor, a sound sensor, an image sensor, a biometric sensor, a physiological sensor. Further, in some embodiments, the one or more mobile devices may include a wearable device such as, for example, a fitness band. Accordingly, the sensor data may include one or more of a physiological variable (such as heart rate, and blood pressure), a physical variable (such as a number of steps walked, and a distance covered by walking and/or running) and a psychological variable (such as level of stress as determined from correlation with physiological variables such as heart rate, EMG, and EEG).

In some embodiments, the method 700 may further include analyzing, using the processing device, the sensor data. Further, the generating of the one or more prediction models may be further based on the analyzing of the sensor data at 704.

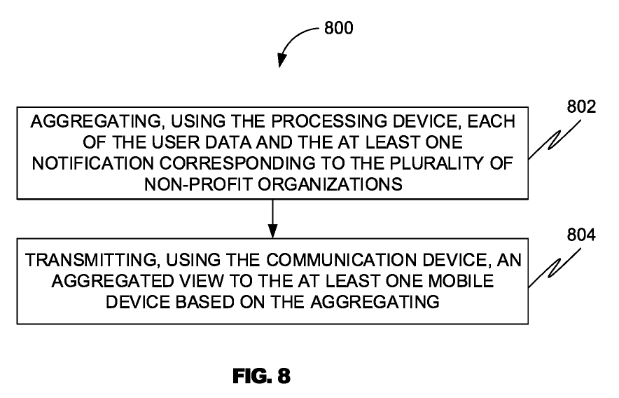

FIG. 8 illustrates a flowchart of a method 800 for facilitating multiple entities, in accordance with some embodiments. An entity may include the multiple entities. Accordingly, at 802, the method 800 may include aggregating, using the processing device, each of the user data and the one or more notifications corresponding to the multiple entities. Then, at 804, the method 800 may include transmitting, using the communication device, an aggregated view to the one or more mobile devices based on the aggregating. In some embodiments, the aggregated view may enable a user to manage multiples events and/or corresponding notifications associated with multiple entities. For example, in some embodiments, the aggregated view may facilitate distribution of a total budget specified by the user among the multiple events, corresponding notifications and the multiple entities.

FIG. 9 is a block diagram illustrating linking of customized mobile applications of various non-profit organizations for a particular member, in accordance with an exemplary embodiment. Each of the various non-profit organizations may own their own version of the customized mobile application. Each non-profit organization will have members who will have access to their customized mobile application. Further, each member may be part of multiple organization. For example, a member Harpal Singh 900 may be a part of various organizations such as Dallas Sandwich Club 902, Plano Bicycle Club 904, Jagdeep Namm Simran 906, Guneet Bhangra 908, Tanti Sazaj Classical Music 910, Gurdwara Singh Sabha 912 and Sikhri 914. One or both of the platform 100 and the system 200 may link all the multiple organizations for the member (Harpal Singh 900). This may provide the member an aggregated view corresponding to all activity across the various organizations.

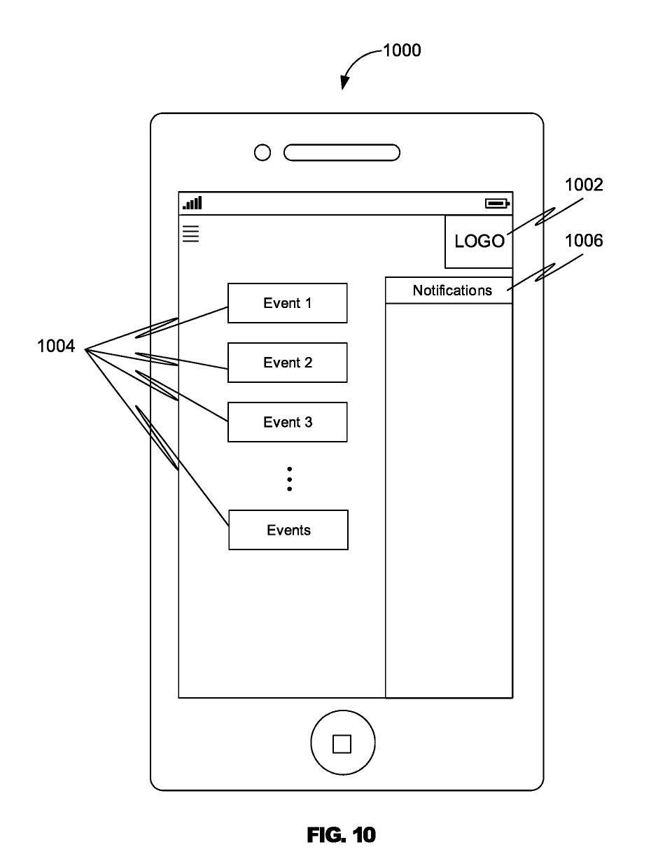

FIG. 10 illustrates a user interface 1000 of a customized mobile application, in accordance with an exemplary embodiment. The user interface 1000 may include a logo 1002 of the corresponding entity. Further, the user interface 1000 may include one or more buttons 1004 corresponding to one or more events related to the corresponding entity. Moreover, the user interface 1000 may display one or more notifications 1006 received from the corresponding entity.

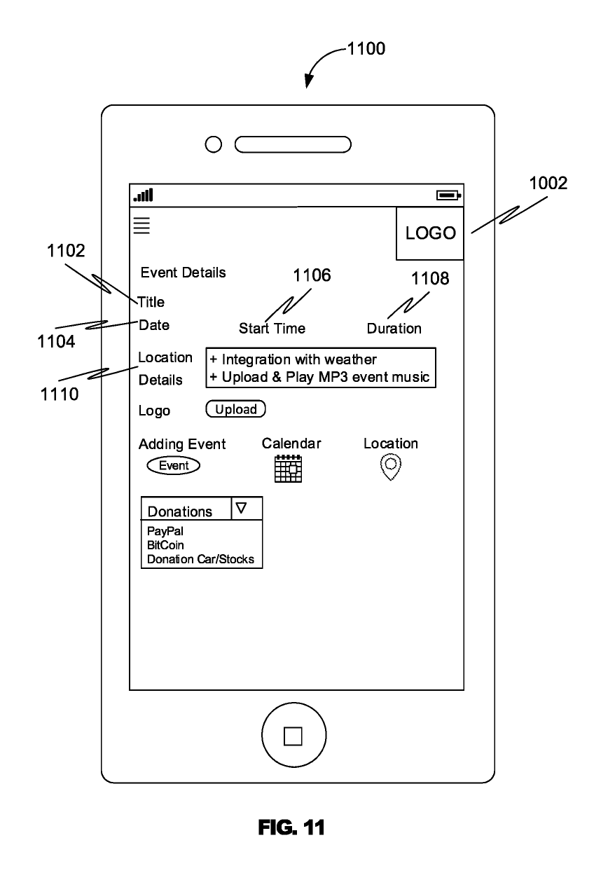

FIG. 11 illustrates a user interface 1100 of a customized mobile application in accordance with an exemplary embodiment. The user interface 1200 may include a logo 1002 of the corresponding entity. The user interface 1200 may allow a user to create a new event by providing event details. The event details may include one or more of Title of the event 1102, Date 1104, Start time 1106, Duration 1108, and Location details 1110.

FIG. 12 is a block diagram of a system including computing device 1200. Consistent with an embodiment of the disclosure, the aforementioned memory storage and processing unit may be implemented in a computing device, such as computing device 1200 of FIG. 12. Any suitable combination of hardware, software, or firmware may be used to implement the memory storage and processing unit. For example, the memory storage and processing unit may be implemented with computing device 1200 or any of other computing devices 1218, in combination with computing device 1200. The aforementioned system, device, and processors are examples and other systems, devices, and processors may comprise the aforementioned memory storage and processing unit, consistent with embodiments of the disclosure.

With reference to FIG. 12, a system consistent with an embodiment of the disclosure may include a computing device or cloud service, such as computing device 1200. In a basic configuration, computing device 1200 may include at least one processing unit 1202 and a system memory 1204. Depending on the configuration and type of computing device, system memory 1204 may comprise, but is not limited to, volatile (e.g. random access memory (RAM)), non-volatile (e.g. read-only memory (ROM)), flash memory, or any combination. System memory 1204 may include operating system 1205, one or more programming modules 1206, and may include a program data 1207. Operating system 1205, for example, may be suitable for controlling computing device 1200′s operation. In one embodiment, programming modules 1206 may include image encoding module, machine learning module and image classifying module. Furthermore, embodiments of the disclosure may be practiced in conjunction with a graphics library, other operating systems, or any other application program and is not limited to any particular application or system. This basic configuration is illustrated in FIG. 12 by those components within a dashed line 1208.

Computing device 1200 may have additional features or functionality. For example, computing device 1200 may also include additional data storage devices (removable and/or non-removable) such as, for example, magnetic disks, optical disks, or tape. Such additional storage is illustrated in FIG. 12 by a removable storage 1209 and a non-removable storage 1210. Computer storage media may include volatile and nonvolatile, removable and non-removable media implemented in any method or technology for storage of information, such as computer-readable instructions, data structures, program modules, or other data. System memory 1204, removable storage 1209, and non-removable storage 1210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1200. Any such computer storage media may be part of device 1200. Computing device 1200 may also have input device(s) 1212 such as a keyboard, a mouse, a pen, a sound input device, a touch input device, etc. Output device(s) 1214 such as a display, speakers, a printer, etc. may also be included. The aforementioned devices are examples and others may be used.

Computing device 1200 may also contain a communication connection 1216 that may allow device 1200 to communicate with other computing devices 1218, such as over a network in a distributed computing environment, for example, an intranet or the Internet. Communication connection 1216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1204, including operating system 1205. While executing on processing unit 1202, programming modules 1206 (e.g., application 1220) may perform processes including, for example, one or more stages of methods 300, 400, 500, 600, 700, and 800 as described above. The aforementioned process is an example, and processing unit 1202 may perform other processes.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may, in fact, be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention.

I/We claim:

1. A method of facilitating operation of an entity, the method comprising:
receiving, using a communication device, an event data corresponding to an event associated with the entity;
receiving, using the communication device, user data from a plurality of mobile devices associated with a plurality of users;
identifying, using a processing device, at least one user based on each of the event data and the user data;
transmitting, using the communication device, at least one notification to the at least one mobile device based on the identifying; and
receiving, using the communication device, an indication of a donation from the at least one mobile device, wherein the donation is associated with the event.

2. The method of claim 1 further comprising:
receiving, using the communication device, customization data associated with the entity from a user device;
generating, using the processing device, a customized user interface associated with the entity; and
transmitting, using the communication device, the customized user interface to the at least one mobile device.

3. The method of claim 1 further comprising:
transmitting, using the communication device, a payment gateway to the at least one mobile device;
receiving, using the communication device, payment information associated with the donation from the at least one mobile device;
crediting, using the processing device, an entity account associated with the entity based on the payment information.

4. The method of claim 3 further comprising:
determining, using the processing device, a service fee based on the donation, wherein the service fee is associated with an online platform configured to facilitate operation of the entity; and
crediting, using the processing device, a platform account associated with the online platform based on the service fee.

5. The method of claim 1, wherein the user data comprises at least one user response corresponding to the at least one notification from the at least one mobile device, wherein the method further comprises:
analyzing, using the processing device, the at least one user response; and
generating, using the processing device, at least one prediction model associated with the at least one user based on the analyzing.

6. The method of claim 5, wherein the transmitting of the at least one notification to the at least one mobile device is based on the at least one prediction model.

7. The method of claim 5 further comprising customizing, using the processing device, the at least one notification based on the at least one prediction model.

8. The method of claim 5 further comprising determining, using the processing device, at least one indication of at least one type of donation based on the at least one prediction model, wherein the at least one notification comprises the at least one indication of at least one type of donation.

9. The method of claim 5, wherein the user data further comprises sensor data corresponding to at least one sensor comprised in the at least one mobile device, wherein the method further comprises analyzing, using the processing device, the sensor data, wherein the generating of the at least one prediction model is further based on the analyzing of the sensor data.

10. The method of claim 1, wherein the entity comprises a plurality of entities, the method further comprising:
aggregating, using the processing device, each of the user data and the at least one notification corresponding to the plurality of entities; and
transmitting, using the communication device, an aggregated view to the at least one mobile device based on the aggregating.

11. A system for facilitating operation of an entity, the system comprising:
a communication device configured for:
receiving an event data corresponding to an event associated with the entity;
receiving user data from a plurality of mobile devices associated with a plurality of users;
transmitting at least one notification to the at least one mobile device associated with at least one user;
receiving an indication of a donation from the at least one mobile device, wherein the donation is associated with the event; and
a processing device configured for identifying the at least one user based on each of the event data and the user data.

12. The system of claim 11, wherein the communication device is further configured for:
receiving customization data associated with the entity from a user device; and
transmitting the customized user interface to the at least one mobile device, wherein the processing device is further configured for generating a customized user interface associated with the entity.

13. The system of claim 11, wherein the communication device is further configured for:
transmitting a payment gateway to the at least one mobile device;
receiving payment information associated with the donation from the at least one mobile device, wherein the processing device is further configured for crediting an entity account associated with the entity based on the payment information.

14. The system of claim 13, wherein the processing device is further configured for
determining a service fee based on the donation, wherein the service fee is associated with an online platform configured to facilitate operation of the entity; and
crediting a platform account associated with the online platform based on the service fee.

15. The system of claim 11, wherein the user data comprises at least one user response corresponding to the at least one notification from the at least one mobile device, wherein the processing device is further configured for:
analyzing the at least one user response; and
generating at least one prediction model associated with the at least one user based on the analyzing.

16. The system of claim 15, wherein the transmitting of the at least one notification to the at least one mobile device is based on the at least one prediction model.

17. The system of claim 15, wherein the processing device is further configured for customizing the at least one notification based on the at least one prediction model.

18. The system of claim 15, wherein the processing device is further configured for determining at least one indication of at least one type of donation based on the at least one prediction model, wherein the at least one notification comprises the at least one indication of at least one type of donation.

19. The system of claim 15, wherein the user data further comprises sensor data corresponding to at least one sensor comprised in the at least one mobile device, wherein the processing device is further configured for analyzing the sensor data, wherein the generating of the at least one prediction model is further based on the analyzing of the sensor data.

20. The system of claim 11, wherein the entity comprises a plurality of entities, wherein the processing device is further configured for aggregating each of the user data and the at least one notification corresponding to the plurality of entities, wherein the communication device is configured for transmitting an aggregated view to the at least one mobile device based on the aggregating.
